(19) United States
(12) Patent Application Publication
(10) Pub. No.: US 2009/0199355 A1
(43) Pub. Date: Aug. 13, 2009

(54) Ozone Toothbrush

(75) Inventor: Jian Yuan, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SHENZHEN JINGRUI INDUSTRY CO., LTD, SHENZHEN GUANGDONG PROVINCE (CH)

(21) Appl. No.: 11/990,576

(22) PCT Filed: May 9, 2006
(86) PCT No.: PCT/CN2006/000925

§ 371 Date: Jan. 14, 2009

(30) Foreign Application Priority Data
Aug. 17, 2005 (CN) 200520063464.3

(51) Int. Cl. A46B 13/02; B01J 19/00

(52) U.S. Cl. 15/4; 422/186.07

(57) ABSTRACT

An ozone toothbrush is comprised of a main body, a brush head which is provided on one end of the main body and a power connection device which is provided on the other end of the main body. An ozonizer and a gas-pressurized device which can supply ozone generated by the ozonizer to the brush head through a transmission channel are provided in the main body. The brush head can be axially connected to the main body by spiral engagement or insertion, or can be radially connected to the main body by spiral engagement or insertion.

### FIELD OF THE INVENTION

The present invention relates to toothbrush, more particularly, to an ozone toothbrush with flexible structure.

### BACKGROUND OF THE INVENTION

There are different designs for ozone toothbrush with bactericidal functions. However, the current ozone toothbrushes have complicated structures and bad versatility, can't satisfy people's various demands of functions. For example, it is hard to be accepted that the brush head can't be changed conveniently, and the power consumption of the toothbrush by using battery only is so high. Meanwhile, the high cost is also hard to be accepted. So, the popularization and usage of the ozone toothbrush are affected directly.

### SUMMARY OF THE INVENTION

One aspect of the present invention is to provide a new kind of ozone toothbrush with simple structure, low cost, flexible replacing scenario for the brush head and flexible scenario for power supply. It may overcome the said disadvantage and solve the problems in the prior art perfectly.

According to an aspect of the present invention, an ozone toothbrush is provided, comprising a main body, a brush head which is provided on one end of the main body and a power connection device which is provided on the other end of the main body; and an ozonizer and a gas-pressurized device which can supply ozone generated by the ozonizer to the brush head through a transmission channel are also provided in the main body.

Advantageously, the brush head is axially connected to the main body by threaded engagement or insertion, and the ozone generated in the main body is sent out from an overflow vent and/or overflow slot provided on a end face of the threaded engagement or insertion connection.

Advantageously, the brush head is radially connected to the main body or axially connected to the main body by insertion, and the ozone generated in the main body is sent out from an overflow vent and/or overflow slot provided on the main body.

Advantageously, the brush head is axially connected or radial connected to the main body by insertion, and the ozone generated in the main body is sent out from a venthole on the main body, and through holes between bristles on the brush head.

Advantageously, the brush head comprises a base board, several binds of bristles on the base board and an interface device used to connect the said base board and the main body.

Advantageously, the main body comprises a handle part, and a connecting pole connected between the brush head and the handle part.

Advantageously, the power connection device is a jack for connecting external electrical source or an interface device for installing a battery box movably.

Advantageously, a battery box used for placing batteries is fixed at the end side of the power connection device.

Advantageously, a battery box used for placing batteries is movably installed at the end side of the power connection device.

Advantageously, induction coils are provided around the battery box, and the ozonize toothbrush also comprises a induction charging circuit connected between the induction coils and the rechargeable batteries.

Advantageously, the gas-pressurized device comprises a tympanum micro-pump or a micro-fan, and the ozonizer comprises a high voltage generating circuit and a metal discharge device, or an ozonizer tube, or a ceramic element, placed opposite to each other.

Advantageously, the ozonize toothbrush also comprises an oscillating unit driven by the power connection device, which provide oscillation to the toothbrush, wherein the oscillating unit may be an eccentric motor.

The ozone toothbrush provided in the present invention has the following prominent advantages compared with the prior art:

1. the main body without batteries enables the power supply structure to be more flexible; the toothbrush may connect with external electrical source wire, and also may be installed with a battery box;

2. the brush head is not contained on the main body, but movably connected with the main body, so that the change of the brush head is more convenient and rapid;

3. Since the ozone generized in the hollow main body is pressurized output, so it is easier for ozone to enter into associated positions in the process of brushing tooth.

### BRIEF DESCRIPTION OF THE DRAWINGS

The features of the present invention will be more fully understand from the following description and drawings.

FIG. 1 is a structural diagram of the ozone toothbrush according to a first embodiment of the present invention.

FIG. 2 is a partial structural diagram of the ozone toothbrush according to a second embodiment of the present invention.

FIG. 3 is a partial structural diagram of the ozone toothbrush according to a third embodiment of the present invention.

FIG. 4 is a partial structural diagram of the ozone toothbrush according to a fourth embodiment of the present invention.

FIG. 5 is a partial structural diagram of the ozone toothbrush according to a fifth embodiment of the present invention.

FIG. 6 is a structural diagram of the ozone toothbrush according to a sixth embodiment of the present invention.

### DETAILED DESCRIPTION OF THE PREFERRED EMBODIMENT

In the ozone toothbrush according to the first embodiment of the present invention illustrated in FIG. 1, a brush head 2 is provided on one end of the main body 1 and a power connection device 3 is provided on the other end of the main body 1. An ozonizer 4 and a gas-pressurized device 5 which can supply ozone generated by the ozonizer 4 to the brush head through a transmission channel 5 are also provided in the hollow main body 1. Wherein, the gas-pressurized device 6 is a tympanum micro-pump or a micro-fan, and the ozonizer 4 comprises a high voltage generating circuit, and a metal discharge device, or an ozonizer tube, or a ceramic element, placed opposite to each other. Here, the power connection device 3 may be a jack used for external power, which may provide power supply for the ozone toothbrush through a low voltage power wire. It is economical but comparatively not so convenient. Furthermore, the power connection device 3 also may be an interface apparatus which enables to install a battery box movably, and in this way, the ozonizer and the fan is power supplied through the batteries in the battery box. Since the battery box is external connected, the replacing of the batteries is more convenient, and the mold may be simplified. The battery box also may be fixed on the end face of the power connection device 3, used for placing batteries, and in this way, the battery box and the main body become a whole. The main body may be divided into a handle part, and a connecting pole connected between the brush head and the handle part.

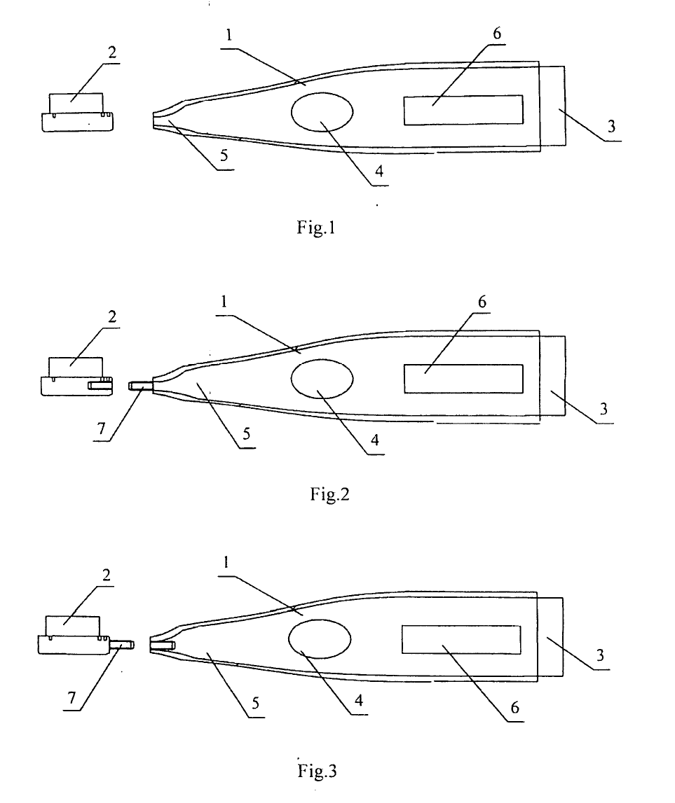

The detail of the connection between the brush head and the main body is illustrated in the FIG. 2. As shown in FIG. 2, the brush head 2 can be axially engaged with the main body 1 by a thread 7, and the ozone generated by the ozonizer 4 in the hollow main body 1 is sent out from the overflow vent and/or overflow slot provided on the thread end face. In this way, the brush head 2 can be assembled and unassembled conveniently through rotation, which enables the replacing of the brush head to be very convenient. FIG. 3 illustrates another structure of the thread connection.

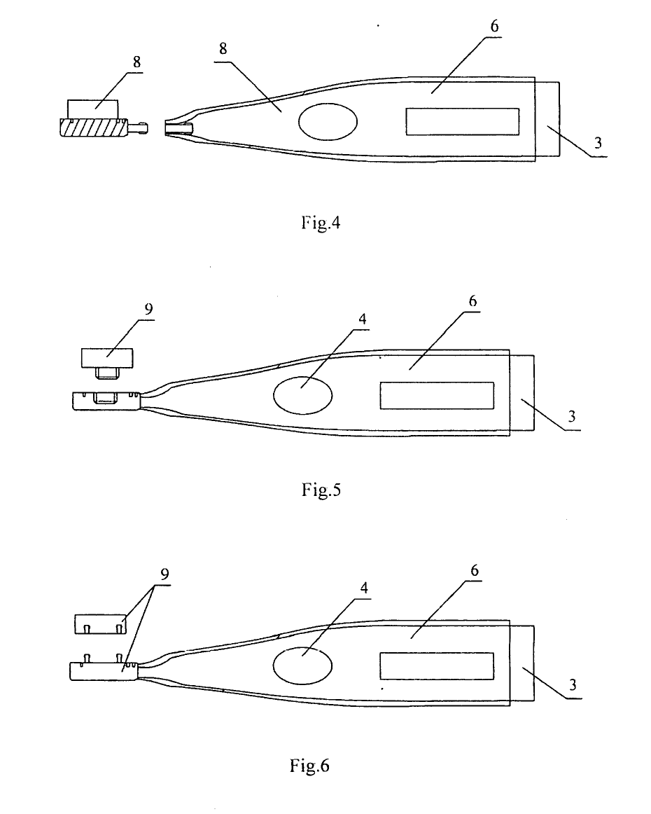

Another detail of the connection between the brush head and the main body is illustrated in the FIG. 4. As shown in FIG. 4, the brush head 2 can be axially connected to the main body 1 by insertion through the insertion apparatus 8. The ozone generated by the ozonizer 4 in the hollow main body 1 is sent out from the overflow vent and/or overflow slot (not shown) provided on the end face of the insertion apparatus. Similarly, the brush head 2 can be inserted into the main body or removed from the main body conveniently, and the replacing of the brush head is very convenient.

In the embodiment illustrated in the FIG. 5, the brush head 2 can be radially connected to the main body 1 by thread engagement. The ozone generated by the ozonizer 4 in the hollow main body 1 is sent out from the overflow vent and/or overflow slot provided on the main body 1. Here, the brush head 2 comprises a base board, several binds of bristles on the base board and a thread/screw structure 9 used to connect the said base board and the main body.

In the embodiment illustrated in the FIG. 6, the brush head is radially connected to the main body by movable insertion through a insertion apparatus 10, and the ozone generated by the ozonizer 4 in the hollow main body 1 is sent out from the overflow vent and/or over-flow slot provided on the main body 1. Here, the overflow vent and/or overflow slot is opposite to the brush head.

In the other embodiment of the present invention, the power connection device 3 at one end of the hollow main body is an interface apparatus which may be used for installing a battery box movably. Inductance coils are provided around the battery box, and the power connection device 3 also comprises an induction charging circuit connected between the induction coils and the rechargeable batteries. In this way, the ozone toothbrush can be recharged through a external induction charger, and the cost for using this toothbrush is greatly reduced.

1. An ozone toothbrush, comprising
a main body having a transmission channel;
a brush head provided on one end of the main body;
a power connection device provided on the other end of the main body;
an ozonizer for generating ozone; and
a gas-pressurized device for supplying the generated which can supply ozone generated to the brush head through the transmission channel of the main body.

2. The ozone toothbrush according to claim 1, wherein the brush head is axially connected to the main body by threaded engagement or insertion, and the ozone generated in the main body is sent out from an overflow vent and/or overflow slot provided on an end face of the threaded engagement or insertion connection.

3. The ozone toothbrush according to claim 1, wherein the brush head is radially connected to the main body or axially connected to the main body by insertion, and the generated ozone in the main body is sent out from an overflow vent and/or overflow slot provided on the main body.

4. The ozone toothbrush according to claim 1, wherein the brush head is axially connected or radial connected to the main body by insertion, and the generated ozone in the main body is sent out from a venthole defined on the main body, and through holes between bristles on the brush head.

5. The ozone toothbrush according to claim 1-4, wherein the brush head comprises a base board, several binds a plurality of bundles of bristles formed on the base board and an interface device used to connect the base board and the main body.

6. The ozone toothbrush according to claim 1-4, wherein the power connection device comprises a jack for connecting external electrical source or an interface device for installing a battery box movably.

7. The ozone toothbrush according to claim 1-4, further comprising a battery box used for placing batteries fixed at the end side of the power connection device.

8. The ozone toothbrush according to claim 1-4, further comprising a battery box used for placing batteries movably installed at the end side of the power connection device.

9. The ozone toothbrush according to claim 7, further comprising induction coils provided around the battery box, and wherein the ozonize toothbrush further comprises a induction charging circuit connected between the induction coils and the rechargeable batteries.

10. The ozone toothbrush according to claim 1, wherein the gas-pressurized device comprises a tympanum micro-pump or a micro-fan, and the ozonizer comprises a high voltage generating circuit and a metal discharge device, an ozonizer tube, or a ceramic element, placed opposite to each other.

11. The ozone toothbrush according to claim 1, further comprising an oscillating unit installed in the main body and driven by the power connection device.
